(19) United States
(12) Patent Application Publication
(10) Pub. No.: US 2009/0274811 A1
(43) Pub. Date: Nov. 5, 2009

(54) Defect separation from dry pulp

(76) Inventors: Brock Lundberg, Roberts, WI (US); Dustin Scheffler, Wanamingo, MI (US)

Correspondence Address: MARK A. LITMAN & ASSOCIATES, P.A.;York Business Center, Suite 205, 3209 West 76th Street, Edina, MN, 55435, US

(21) Appl. No.: 12/387,343

(22) Filed: May 1, 2009

Related U.S. Application Data
(60) Provisional application No. 61/126,124, filed on May 1, 2008.

(51) Int. Cl. A23L 1/20; A23P 1/02

(52) U.S. Cl. 426/453; 426/481

(57) ABSTRACT

Defects are removed from dry pulp by providing dry pulp having less than 10% by total weight of water therein. The location of individual defect material within the dry pulp is sensed. The located defect material is relatively positioned with respect to a defect removal system. Using the sensed location of defect material with respect to the defect removal system, the defect material is removed with the defect removal system from the dry pulp.

### RELATED APPLICATIONS

This application claims priority from provisional U.S. application Ser. No. 61/126,124, filed May 1, 2008.

### BACKGROUND OF THE INVENTION

1. Field of the Invention

The present invention relates to the provision of pulp from agricultural products having reduced defects contained therein. In particular, the present invention relates to the removal of defects, such as dark seed fragments from vegetable or fruit pulp, including native (untreated) fruit pulp in a cost efficient and time efficient manner.

2. Background of the Art

A major problem in the provision of volumes of agricultural materials such as grains, pulp and flour is the accidental inclusion of spurious organic matter and particularly seed fragments and dead insects and insect parts. Whether or not these insects parts or fragments have any actual health risk, they lower the value of the products and have caused cancellation of orders. In a world of large volume agricultural production that is usually mechanized at various processing or packaging stations, the entry of seed fragments and insects into the system is commonplace.

It is desirable to provide methods and systems to avoid the provision of defects, including insect parts in shipped products, the defects possibly including, e.g., seed fragments, dried insect bodies, insect fragments, larvae, black or brown specs from vegetable matter, and the like. The problem of particle contaminants is particularly apparent and more difficult to address in citrus pulp. There is a known problem with larvae and other dark specs being present in citrus pulp materials and the problem can be extreme during certain periods of the year and locations. For instance, larvae are generally worse later in the fruit harvesting season as the fruit passes its maturity stage and is more susceptible to insect attack. Additionally, the larvae problem is generally more profound in imported fruit from outside the United States. Fruit pulp typically also contains dark specs that can come from portions of seed that end up in the pulp.

In traditional methods of using sorting equipment to remove dark specs and larvae from orange pulp, the pulp is spread on a thin layer on a conveyor belt, or similar flat surface, and it passes through an automatic viewing system while the pulp is in a wet basis. The automated detection system (the viewing system) scans or takes an image of the wet pulp, and exercises optical data discretion in identifying defects, usually based on color differences. The system then automatically ejects the rejects material, as with air jets blowing off material, mechanical pickers, or elevator segments on the conveyor lifting regions of the conveyor surface from which raised material is then removed. Among numerous problems that the present inventors have identified with this process is the fact that the wet pulp material is swollen and takes up a much larger volume as compared to when the pulp is dry, and the defect material may tend to not swell as much making removal of defects more difficult. The wet pulp also presents two additional problems that have not been identified or addressed by previous technology. First, the viscosity of the wet pulp material is high and because it is viscous as it comes out of the orange juice processing operation, e.g., as 5-10% solids, it needs either water or juice added to it before it can be scanned. Adding water to the wet pulp reduces the consistency and solids content of the pulp add another step in the process, and this addition does not actually assist in physical removal of defects. Therefore, by adding water or juice to the pulp just to scan it through the machine vision system makes the process costly as both the capital and operating costs (additional drying energy is required or additional water incorporation and mix steps are required) will be higher. Numerous efforts have been made in the past to provide organic matter removal from vegetable, fruit and nut products.

U.S. Pat. No. 5,845,002 (Heck et al.) describes how the topographic surface features of a translucent object, such as a citrus fruit with a peel, are scanned and evaluated to permit the classification thereof according to its surface features. In the case of citrus fruit, the coarseness or pebbliness, puff and crease, ridge and valley, cuts, punctures, scrapes and splits, clear rot or sour rot of the peel is optically identified through digital analysis of the pixel scans and sorted based upon the peel surface quality. The object is classified by separating the scanned image of the fruit from the background image and removing the background image. A statistical evaluation of the image of the object as a whole, including both hemispheres of the object, is made to determine if there is any surface feature variation which might qualify as a defect or be a suitable basis upon which a classification judgment can be made. If there is, the object image is subject to high frequency or low pass filtering and thresholding of the pixel intensities to derive a refined image. The refined image is then tabulated or organized into neighborhoods contiguous to sharp transitions or gradual transitions to identify specific areas defined as blobs which, when compared against a given minimum area, shape requirement and/or width can be identified as one of the surface imperfections sought. The method of classifying a translucent object having a surface with at least one of a plurality of possible surface feature patterns, with the object being classified according to said at least one possible surface feature pattern, comprises the steps of: illuminating the object to cause light to be scattered therein; detecting such scattered light transmitted through the surface of the object; converting such detected light to data representing the relative intensity of light transmitted through each of a plurality of defined areas of the surface; analyzing such data to determine the existence of said at least one surface feature pattern; and classifying the object on the basis of determination of said surface feature pattern, wherein said step of analyzing the data comprises deriving a statistical measure of the data characteristic of said at least one surface feature pattern in order to identify said at least one surface feature pattern from among said plurality of surface feature patterns possible for said object, wherein the step of detecting further comprising the step of optically forming an image of the transmitted scattered light from the object, and wherein said object is illuminated with a source having an optical beam and said step of optically forming an image comprises optically reflecting an image of only the scattered light transmitted from the object into a camera pointed away from the object and not in said optical beam of said source.

U.S. Pat. No. 5,174,429 (La Vars) describes a conveyor discharge apparatus, and a related method of operation, that can lift and thereby eject any article carried by a conveyor of the apparatus through substantially relying on the motor that advances the conveyor of the apparatus. The apparatus includes an ejection mechanism having a plurality of ejection fingers that are each associated with a separate one of the pockets of the conveyor and are selectively movable between rest and ejection positions so as to lift and eject articles carried by the pocket in which the particular finger is located. The ejection mechanism is further configured such that the power required to lift and eject any article from the pockets is provided substantially by the motor that advances the conveyor. In operation, the conveyor is advanced via the motor and the fingers are selectively moved substantially via the power of the motor from their respective rest positions to their respective ejection positions.

U.S. Pat. No. 5,791,497 (Campbell) describes a method of separating selected fruit from a volume of fruit is based on the reflectivity of the selected fruit. The method utilizes an automated optical inspection and sorting system to illuminate a volume of fruit including cranberries characterized by a spectral power distribution in the infrared spectral region. The system detects reflections of wavelengths of the illumination in the infrared spectral region, identifies the selected fruit based on the detected reflectivity, and sorts the selected fruit from the volume of fruit.

U.S. Pat. No. 5,732,147 (Tao) describes an image processing system using cameras and image processing techniques to identify undesirable objects on roller conveyor lines. The cameras above the conveyor capture images of the passing objects. The roller background information is removed and images of the objects remain. To analyze each individual object accurately, the adjacent objects are isolated and small noisy residue fragments are removed. A spherical optical transform and a defect-preservation transform preserve any defect levels on objects even below the roller background and compensate for the non-lambertian gradient reflectance on spherical objects at their curvatures and dimensions. Defect segments are then extracted from the resulting transformed images. The size, level, and pattern of the defect segments indicate the degree of defects in the object. The extracted features are fed into a recognition process and a decision making system for grade rejection decisions. The locations in coordinates of the defects generated by a defect allocation function are combined with defect rejection decisions and user parameters to signal appropriate mechanical actions such as to separate objects with defects from those that are defect-free.

U.S. Pat. 7,024,942 (Jackson, et al.) describes a NIR or machine vision for use of scanning dried fruit products and removing defects such as pits for fruit that contains pits. The apparatus for non-destructive detection of pits and seed fragments in dried fruit may include a conveyor belt; a first roller for partially flattening a fruit specimen; a second roller for applying modulated force on said partially flattened fruit specimen; means to measure the amount of said modulated force which is transmitted by said second roller through said fruit specimen; and means to reject a fruit specimen which transmits a level of force at or above a threshold level. The apparatus is also described as comprising a continuous belt; power-actuated roller means for setting said belt in motion; compressing means for compressing dried fruit to be tested for the presence of pits or pit fragments; detection means for determining whether said compressed dried fruit contains a pit or pit fragment; and rejection means for rejecting dried fruit containing a pit or pit fragment.

In the removal of pits and pit fragments, the U.S. fruit industry employs a combination of devices and proprietary techniques to rid fruit of pits and pit fragments. One popular device in use is the Elliot pitter, for example, which smashes the fruit between two rollers, squeezing the pit out (and sometimes crushing or cracking the pit itself, leaving behind pit fragments). Another device in use is the Ashlock pitter which employs a conveyor system with mechanical cups holding each piece of fruit in place during the pitting operation. This device uses a pitting head comprised of eight needles, each of which pierces a dried plum and forces the pit out of the fruit and into a pit tube. Up to eight dried plums, therefore, can be pitted with each stroke of the pitting head, assuming each needle successfully engages a single fruit. When the machine is working properly very few pits are missed. However, when the needles are damaged or out of alignment, many pits can be missed or fragmented. The machine requires monitoring and quick maintenance in order to ensure efficient operation, and less than optimal performance can result in a large amount of pits being missed in a short time. Both of these devices, along with other techniques and devices in use, leave behind the occasional pit or pit fragment. Once the fruit has been through the pitting process, it is necessary to test it for residual pits and pit fragments that may remain. Different methods and devices have been developed for this process and several patents exist on devices for detection of pits in fruit in general. So far, none of these devices adequately addresses the problem. Examples of how others have (inadequately) addressed the problem are set forth below. One device which has been patented is based on transmission of visible light (U.S. Pat. No. 3,275,136 (Allen et. al.) for detecting seeds in fruit, including cherries. U.S. Pat. No. 4,666,045 (Gillepsie et al.) discloses a device based on transmittance and sensing of laser light for use with comestibles such as cherries, peaches and other types of fruit containing pits).

There are a number of patented devices that make use of physical sensors, including force transducers and accelerometers, to evaluate fruit quality, especially for ripeness and firmness. See U.S. Pat. No. 6,240,766 (Cawley); U.S. Pat. No. 5,315,879 (Crochon); and U.S. Pat. No. 6,553,814 (deGreef). All of these devices are designed to evaluate the surface quality or density of the fruit.

There are also an increasing number of customers that collect citrus pulp as a byproduct to sell for additional revenue. Thus, an increasing number of customers require citrus pulp to be processed with large and intact pulp sacks. One way to accomplish this goal is to design a juice extractor having larger openings in the strainer tube. Although larger, intact pulp sacks would be processed, the use of larger openings in a strainer tube has drawbacks, however, because undesired material and citrus pulp defects could pass through the slots.

One prior art solution is a premium pulp system using a juice extractor, followed by processing at a juice finisher, and further processing for cleaning in a fluidized bed cyclone in which pulp and juice are processed together to separate components out by gravity. The design of the fluidized bed cyclone allows fluid to enter in tangentially and spin, with 20-30% of pulpy juice ejected from the bottom and 70% ejected from the top as a pulp andjuice product. In a preferred mode of operation, small seeds and peel particles are ejected from the bottom portion of the fluidized bed cyclone.

There are some drawbacks to this system because the defects that are processed as part of the juice and citrus pulp are unacceptable to many customers. These defects may include discolored pulp, peel or portions of peel, albedo or portions of albedo, seeds, portions of seeds, black specks, mold, and non-citrus material such as insects, insect larvae or insect parts. Different customers have different specifications concerning these defects, depending on the citrus pulp defect, category of juice, and customer end use. In some cases, defects are unacceptable at any level, such as insect larvae.

U.S. Pat. No. 6,727,452 (Schrader) describes a system and method of the present invention removes defects from citrus pulp. An advancing mechanism advances citrus pulp along a predetermined path of travel into an inspection zone. A citrus pulp imager is positioned at the inspection zone and acquires image data of the citrus pulp. A processor is operatively connected to the citrus pulp imager and receives the image data and processes the image data to determine defects within the citrus pulp. A rejection mechanism rejects any citrus pulp determined to be defective.

All references cited herein are incorporated herein in their entirety as part of the present disclosure.

### SUMMARY OF THE INVENTION

Fruit pulp is first dried, provided on a surface, observed for defect content (non-analogous material), and the defects material removed. By first removing substantial moisture content from pulp, the volume of material that is to be inspected and cleansed of defects, and the contrast between defect and desired pulp is increased. This facilitates numerous aspects of the process for removal of defects, increases the accuracy of removal and reduces energy and capital costs in the process.

### BRIEF DESCRIPTION OF THE FIGURE

FIG. 1 shows a schematic of one embodiment of a system useful in the practice of the present technology.

### DETAILED DESCRIPTION OF THE INVENTION

The general methods according to the present technology may include a method of removing defect-containing dry pulp from pulp mass. A supply of dried pulp is provided The pulp preferably is provided in a reasonable flowable or non-agglomerated mass and is moved within a separation system. The system optically identifies defect-containing dry pulp by optical sensing while the dry pulp is moving. The defect-containing pulp is distinguished from the defect-containing pulp by the sensing. It is possible that sensing may be done by differential electrical transmission also, as defect-containing pulp will have a different electrical resistance than defect-free pulp. The defect-containing dry pulp sensed by optical sensing is ejected (mechanically by a plunger or scraper, or by focused or directed gas pressure (e.g., gas jet). The defect-containing fiber is ejected into a fiber rejection port to be carried away. Two separate ports or conduits or trains of pulp particles are produced, the defect-containing pulp and the defect-free pulp trains. The system collects dry pulp from the conduit which has not been ejected. In one method, the dry pulp is provided on a vibrating transport system before or during moving the dry pulp. In another method step, moving the dry pulp may be done by gravity fall of dry pulp. The method may use optical sensing, such as optical density differentiation to distinguish defect-containing pulp from defect-free pulp particles. The agglomeration of the dry pulp is minimized, as by crumbling before being optically sensed to reduce the effective size of particles and the mass of particles that would be rejected because of agglomeration of particles into larger sizes. The procedure may be repeated on the batches of defect-free particles, with or without sensing enhancement or increasing the sensing sensitivity to further refine the fiber pulp product.

Fruit pulp, for example, is first dried (e.g., natural water content reduced or removed, as down to less than 20%, less than 10% total moisture, less than 7% water content, less than 4% water content, and as close to dry as possible under ambient conditions approaching 0% water), provided on a surface (belt, conveyor belt, plate, operating surface and the like), visually or automatically observed for defect content (the presence of non-pulp or non-analogous material with the pulp), and the defects material removed, preferably by mechanical and/or automated removal systems. By first removing substantial moisture content from pulp, the volume of material that is to be inspected and cleansed of defects, and the contrast between defect and desired pulp is increased. This facilitates numerous aspects of the process for removal of defects, increases the accuracy of removal and reduces energy and capital costs in the process. Other pulps may also be used, including both edible and inedible pulp.

The defects are identified by location (as by grid coordinates) on the surface, the automatic (mechanical) removal system removes defects from the identified location, and the dry pulp continues moving into or through a transportation, processing packaging process. Removal can be by vacuum application (upward and vertically off the support or downward through openings in the support), lifting and removal, or picking operations directly off the support. With vacuum application, the location of the vacuum application can be controlled by movement of a lumen to a site, having a coordinate system over or in the support in which vacuum can be applied at specific coordinates, hand application of a vacuum element (especially with coordinate lighting of the surface at defect locations with, for example, LED or semiconductor lighting available on the surface), and the like.

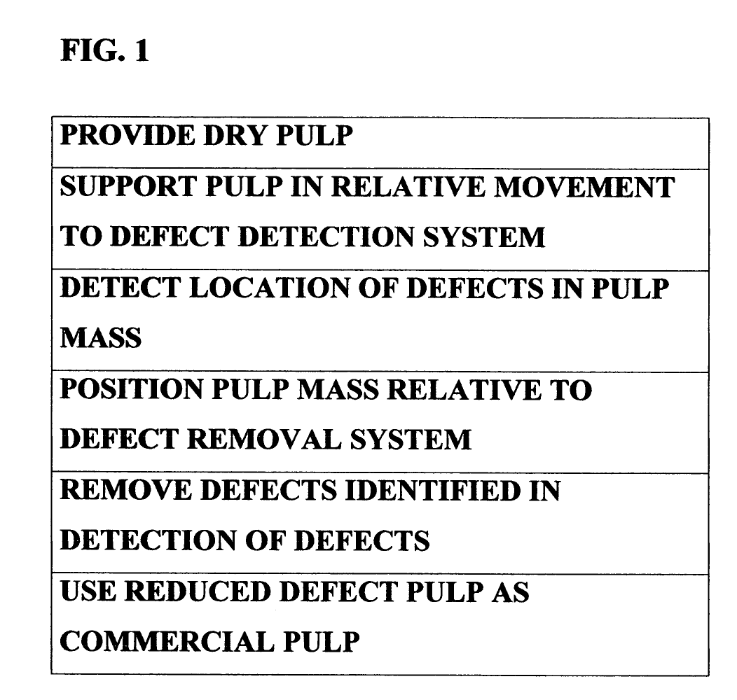

Overall operation of one embodiment of the invention is described in the schematic shown in FIG. 1. Dried pulp (vegetable or preferably fruit) with defects therein (8), such as but not limited to citrus pulp, are introduced in a relatively level and distributed mass onto a conveyor or continuous belt (1). The method of arranging or evening the individual fruit specimens so that pulp mass does not cover excessive amounts of defect on the conveyor belt is optional, alternatives are available and is in part dependant on the size, type, desired efficiency and volume of the processing facility and would have to be designed, altered, manipulated and built for each particular design setup. Evening may be done by vibration, scraping, blowing, leveling gaps, and/or combinations thereof Individual subcomponents (belts, motors, drives, scrapers, blowers, vibrators) to accomplish the individual tasks are already known in the art, but have not been used or combined as described herein. The evened fruit pulp is passed between an initial or first roller (3) or alternatively a scraper or vibrator and the surface of the conveyor belt (1), in effect partially flattening, evening, distributing or compressing the pulp to expose defects before it passes onto the second roller (4). A force transducer (6) may be mounted below the conveyor belt (1) and under the second roller (4), the transducer measuring the force on the belt as the pulp (8) passes under the second roller (4). The rollers are optionally mounted on adjustable shock absorbers (2), which allow the product (8) to pass between the roller and the conveyor belt without damaging any intact material that may be present. The edible portion of the product (8) is relatively pliable and passes through the gap with minimal force applied to the transducer (6), while defects may be removed as by being pushed downward onto the sensor with much greater force. Therefore, when pulp containing defects fragment passes between the second roller (4) and the force transducer (6), a larger output signal results which is detected and processed by the signal processor/decision maker (9) and, for example, a vacuum may be applied through the second roller (4) or through the belt (1) at that specifically identified location of the defect material. The detection may be done by visual detection (automatic or human, e.g., by color or optical density), by electronic resistance (with the difference in resistance between defect and pulp previously identified) or any other detectable procedure. When a defect (e.g., insect part) is detected by the signal processor/decision maker (9), a signal is sent to the rejection mechanism or diverter (7) which then rejects the affected region of pulp specimen from the processing stream.

Conveyor System

The conveyor system consists of a continuous belt which may be coated with metal or made with food grade Teflon® polymer or another material suitable for food processing. The actual dimensions are not critical and may vary, but a typical belt is at least approximately 10 cm wide and at least 2 mm thick. It is mounted on two pulleys, which may be affixed on either end of a suitable frame such as an aluminum bed. The length of the bed is not critical and may vary, but a frame structure or bed of at least 50 cm in length is generally long enough to include all necessary components and fittings. Typically, an electric, variable speed motor powers the pulleys. As an example, a belt speed set at least about approximately 20 or 50 cm/s will correspond to a potential product throughput of about 230 kg/hr or more for large width belts carrying citrus pulp.

Rollers

The preferred embodiment utilizes two rollers. The “first roller” (3) is the roller which the pulp on the conveyor first encounters and is partially distributed by; the “second roller” (4) is the roller which the distributed pulp next encounters, and in between which the visual detection would occur with a camera or sensor takes place. Both rollers may be displaceable and adjustably mounted above the conveyor belt in order to permit the formation of an appropriately sized gap between the bottom of each roller (which may have combing or raking elements attached thereto) and the top of the conveyor. In other words, between the bottom of the roller and the conveyor belt itself there is a gap that the pulp passes through. These rollers are preferably displaceable and adjustable to permit the size of this gap to be modified (increasing or decreasing in width) in order to accommodate different volumes of pulp and different rates of pulp introduction and to accommodate different defect removing components.

The actual dimensions and composition of the first roller are not critical with a coating or surface suitable for food processing such as Teflon(& polymer, silicone polymer, Buna-n rubber, metal, composite, ceramic or the like. The coating adds friction to the pulley enabling the pulp to be distributed as it passes through the gap between the roller and the belt, or may have combs, rake elements, grooves or the like to assist in distributing the pulp and defects before they are examined.

The second roller may be smaller, larger or the same size as the first roller and may also contain a defect removing function, such as coordinate vacuum applicable across its surface as it contacts pulp. Also, this wheel or roller may be power driven (like the first roller), rotating in a direction opposite to the direction of rotation of the pulleys which drive the conveyor belt. This wheel or roller may be coated with friction-inducing material, such as an initial layer of pure gum rubber tubing overlaid with a second layer or. The heat shrink layer provides resistance to moisture and is easy to clean, yet still provides enough friction to force the fruit through the gap. The roller may be also mounted on shock absorbers to provide some shock. These shocks can be adjustable.

The size of the gap between the rollers and the belt is selected based on the size of the fruit being processed and the desired detection sensitivity. While visual detection sensitivity increases with increased distribution and less flattening (compressing) of the pulp, it is desirable to maintain the gap at a distance that is non-destructive to the product. Proper operation of the device is assisted by keeping the rollers free of residue from the pulp and defects. Certain pulp present more of a problem than others, but drying the pulp reduces the adherence of material to rollers, combs and distributing systems.

The present technology performs a process and-system for removing defects from citrus pulp. Pulp is first dried. The dried pulp is provided on a substrate which can be advanced through a processing system. The advancing mechanism receives citrus pulp and forms a substantially planar flow of dried citrus pulp of predetermined thickness moisture content and advances the dried citrus pulp along a predetermined path of travel into an inspection zone. A citrus pulp sensor or imager positioned along or at the inspection zone acquires image data of the citrus pulp and any defects therein. A processor operatively connected to the citrus pulp sensor/imager receives the sensed or image data and processes the sensed or imaged data to determine defects within the citrus pulp; and a rejection mechanism rejects or removes defects or volumes of dried citrus pulp containing defects or determined to be defective. The imager may further comprise a light source for illuminating the citrus pulp at the inspection zone and a camera located at the inspection zone for acquiring images of the citrus pulp and the light source may be operative for illuminating the citrus pulp at a predetermined range of wavelengths for highlighting defects to be illuminated. The advancing mechanism may comprise a belt conveyor, nozzle or translucent material through which citrus pulp is advanced and imaged. The rejection mechanism may alternatively comprise a mechanical diverter that diverts any citrus pulp determined to be defective from the path of travel. The rejection mechanism may alternatively comprise at least one air nozzle for blowing air onto citrus pulp determined to be defective and diverting the defective citrus pulp from the path of travel. The processor may be operative for determining defects including discolored pulp, peel or portions of peel, seeds, portions of seeds, black specks, mold, and non-citrus material including insects, insect larvae or insect parts.

Citrus pulp is separated from juice typically by processing the citrus pulp in a juice extractor, which strains out most of the seeds and membranes through a strainer tube to produce a fine citrus pulp and juice product. This juice product advances and is further processed at a juice finisher for separating citrus pulp from the juice. At this point in the processing, the pulp is somewhat “clean,” after having been broken up into smaller citrus pulp pieces as a result of processing through the strainer tube at the juice extractor.

In accordance with the present invention, a citrus pulp imager may acquire image data of dry citrus pulp at an inspection zone that receives citrus pulp advancing along a predetermined path of travel. A processor is operatively connected to the citrus pulp imager for receiving the image data and processing the image data to determine defects within the citrus pulp. A rejection mechanism rejects or removes any citrus pulp determined to be defective. In one aspect of the present invention, a light source illuminates the citrus pulp at the inspection zone. A camera is located at the inspection zone and acquires images of the dry citrus pulp. This camera can be a line-scan camera, CCD camera, or other imaging camera or similar mechanism that is operative for acquiring images of citrus pulp. A light source illuminates the citrus pulp and is operative at a predetermined range of wavelengths for highlighting defects to be illuminated. In one aspect of the invention, the wavelengths are such as to cause defects to fluoresce. In yet another aspect of the present invention, the advancing mechanism may include a belt conveyor, nozzle or translucent material through which citrus pulp is advanced and can be imaged. The rejection mechanism could include a mechanical diverter that diverts any citrus pulp determined to be defective from the path of travel, or an air nozzle that blows a jet of air onto citrus pulp determined to be defective to eject or divert the defective citrus pulp from the path of travel. In one aspect of the present invention, the processor is operative for determining defects in citrus pulp, including but not limited to, discolored pulp, peel or portions of peel, albedo or portions of albedo, seeds, portions of seeds, black specks, mold, or non-citrus material such as insects, insect larvae or insect parts.

The present invention advantageously overcomes the disadvantages of prior art citrus pulp defect removal systems by using dry citrus pulp as well as sensing/imaging during processing and removing of defects from the citrus pulp in an economical and advanced manner without harming the citrus pulp and damaging its ability to be used in commercial processes. FIG. 1 illustrates a basic block diagram showing key steps in the system and method for removing defects from citrus pulp in accordance with one aspect of the present invention.

FIG. 1 a schematic process according to the present invention in which a dried pulp mass is provided. A defect detection system is moved relative to the dried pulp mass (either the mass is moved, the detector is moved or both are moved). The relative location of defects is identified and the information provided to a processor. A defect removing system is moved relative to the dried pulp mass and defects are removed according to their previously identified location within the pulp mass. The dried pulp mass that has been enhanced by removal of defects may then be used in any commercial process where quality pulp mass can or must be used. The use of dried pulp mass, in contrast to conventional wet pulp offers significant technical and commercial advantages. In the enhancement process itself (removal of defects), the defects, and especially insect parts, separate more easily from the wet pulp, making the physical separation easier to achieve. The wet pulp is stickier and there must be a physical separation of insect parts and pulp solids before the insect part can be removed. Rather than adding more water to the pulp as an alternative method of separating the solids, which would require more energy to later dry the pulp (by having to remove more water), initial drying limits the energy that must be used in total drying processes in pulp utilization. The drying also tends to simplify the visual (automated) detection of the defects in the pulp, as the dried pulp is lighter in color (approaching a pale yellow for citrus pulp) and provides a sharper color contrast to the dark insect parts as compared to the greater color density of the wet pulp. Each of these factors makes the process of the present technology advantageous over the use of separation processes with wet pulp.

A light or radiation source (infrared, ultraviolet) may be used in conjunction with the image detection of the defects to further enhance observation, detection and location of defects in the pulp. By providing the detection information to a processor, and defining the surface (stationary or moving) supporting the dry pulp according to coordinates (e.g., Cartesian coordinates), the location of the defects can be identified relatively precisely, and that precise location may be fed to any type of defect removal system (e.g., mechanical picker, vacuum removal, pushing pieces to and over the edge of the surface, and the like) may precisely and efficiently remove defects without excessive removal of the pulp mass. It is also possible to electrostatically charge areas of the support (e.g., corona discharge) where defects are found, applying a biasing voltage in the region of the charged defects, and either remove the defects by the biasing charge or retain the defects in place when the conveyor belt (for example) reaches a round edge, drops dry pulp into a collector, and continues to carry away adhered charged defects.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

The advantages of the present technology may also include the following features:
1) There are efficiency saving in using dry pulp because more volume must be processed to provide a given weight of product when the original pulp is wet, e.g., as much as thirty times the volume of pulp may be needed.
2) The fruit pulp is swollen in the wet form whereas the larvae does not absorb or swell like the pulp. This tends to mask the larvae because of the increased relative volume of the pulp.
3) The pulp material being enhanced breaks apart and is friable in the dry form, so a water fall type concept where the dried pulp can be conveyed or spread out in an air stream and scanned can be used. That type of high efficiency enhancing procedure is not possible in the a wet product.
4) The high viscosity of the wet pulp means water must be added to the wet pulp to make it thin and transparent enough to be scanned through the equipment in wet form. How%%ever, this is not needed in the dry form because the product can easy be spread/broken apart on a conveyor so that it can be scanned without addition of water. Rather, when the pulp is dry, air can be the thinning medium which is cheaper to remove and easier to perform as compared to water.
5) The energy and waste disposal cost of adding/ removing water rather than air to make the pulp medium more transparent makes the dry process more energy and cost efficient.
6) There is a possibility that upon heating and drying, the larvae or defects will discolor more compared to the pulp. This discoloration in advance of removal makes is easier to remove these types of defects using traditional machine vision equipment.
7) The wet pulp in the soft and swollen form is difficult to reduce to a predetermined particle size on as it takes a lot more energy to reduce pulp particle size in a wet form compared to the dry form. Usually the swollen pulp is of a larger size compared to the defects. We have a theory control of the particle size of the pulp can be performed so that scanning equipment can more easily scan and find the larvae. This can be easily controlled in the prescanning drying process. There needs to be a balance in this regard because the smaller we make the pulp the smaller we are also making the defects and therefore it will be harder to find. On the other hand, if we work with intact dry particles, the larvae or defects will be more easily hid and covered up by the pulp and therefore not removed. Part of an operational theory is that we should control the particle size of the pulp to a certain degree so that the pulp particle sizes are larger than the resolution of the scanning equipment but small enough that the pulp can break apart easily to make for easier scanning. However, we don't want to do a fine grinding of the pulp and defects because if we go below the resolution of the scanning equipment (typically 1 mm) this would make the defects undetectable with the scanning equipment.
8) For several of the reasons outlined above, the number of defects that remain in the enhanced finished product from dry pulp when scanning the pulp is much lower as compared to numbers of defects from the wet product. This means that the dry pulp process can provide a material with fewer defects as compared to products scanned and enhanced from existing equipment using the wet pulp form.

### EXAMPLES

### Example One

Dry citrus fiber was sifted on a 600 micron Sweco style screen to remove the smaller particles under 600 micron in order to improve the sorting capabilities. Dried citrus fiber with defects was placed in a gate discharge type feeder capable of feeding a wide thin layer of fiber. The product then fell onto a vibratory type feeder that is capable of further evening and de-clumping of the fiber prior to entering the optical sorter. The product falls off the vibratory feeder and into the feed chute of the gravity type optical sorter (Mutual, Image 7000: Osaka, Japan). The optical sorter was adjusted to sense 0.3 mm×0.5 mm dark brown/black optical densities for test one removal and 0.5 mm×0.5 mm dark brown/black for test two removal. The sorter detected the dark specks location in free fall and relayed the eject signal to the corresponding eject nozzle at the time the particle passes that nozzle below the camera and diverted the dark speck into a reject chute. The good product continues free fall movement to the good product bin.

| | Color | | | | Amount | Amount | % No- |
|---|---|---|---|---|---|---|---|
| | Density | X | Y | Times of | Good | No-good | good |
| Test | Value | value | value | detection | Product | Product | Product |
| 1 | 25 | 0.3 | 0.5 | 532 | 800 g | 216 g | 21% |
| 2 | 25 | 0.5 | 0.5 | 226 | 1180 g | 70 g | 5.6% |

### Example Two

Citrus fiber was sifted on a 600 micron Sweco style screen to remove the smaller particles under 600 microns to improve the sorting capabilities. Dried citrus fiber with defects was place in a gate discharge type feeder capable of feeding a wide thin layer if fiber. The product then fell onto a vibratory type feeder that is capable of further evening and de-clumping of the fiber prior to entering an optical sorter. The product falls off the vibratory feeder and into the feed chute of the gravity type optical sorter (Radix, Autosort NIC-A: Romsey, England). The optical sorter was adjusted to sense 1.0 mm×1.0 mm dark brown/black for removal. The sorter detects the dark specks location as it slides on a polished chute and relays the eject signal to the corresponding eject nozzle at the time the particle passes that nozzle below the camera and diverts the dark speck into a reject chute. The good product continues through the feed chute to the good product bin. The good product was then re-fed into the optical sorter for further separation

| | | | Amount | Amount | % |
|---|---|---|---|---|---|
| | | | Good | No-good | No-good |
| Pass | X value | Y value | Product | Product | Product |
| Pass 1 | 1.0 | 1.0 | 930 g | 70 g | 7% |
| Pass 2 | 1.0 | 1.0 | 846 g | 84 g | 9% |
| Overall | | | 846 g | 154 g | 15.4% |

Although significant specificity is provided in this disclosure, the intent of the disclosure is to provide a generic concept for practice of the technology. Alternatives and equivalents of the specifics will be apparent to one skilled in the art after review of this specification. The claims should be interpreted in light of that intent.

What is claimed:

1. A method for removing defects from pulp comprising:
providing dry pulp having less than 10% by total weight of water therein;
sensing location of individual defect material within the dry pulp;
relatively positioning located defect material with respect to a defect removal system;
using the sensed location of defect material with respect to the defect removal system; and
removing defects with the defect removal system from the dry pulp.

2. The method of claim 1 wherein the dry pulp is fruit pulp.

3. The method of claim 1 wherein the dry pulp is dry citrus pulp.

4. The method of claim 3 wherein the dry pulp has less than 8% by total weight of water therein.

5. The method of claim 3 wherein the dry pulp has less than 5% by total weight of water therein.

6. A method of removing defect-containing dry pulp from pulp mass comprising:
a) providing dry pulp;
b) moving the dry pulp;
c) optically identifying defect-containing dry pulp by optical sensing while the dry pulp is moving;
d) ejecting defect containing dry pulp sensed by optical sensing into a fiber rejection port; and
e) collecting dry pulp from the conduit which has not been ejected.

7. The method of claim 6 wherein the dry pulp is provided on a vibrating transport system before or during moving the dry pulp.

8. The method of claim 6 wherein moving the dry pulp is done by gravity fall of dry pulp.

9. The method of claim 6 where ejection is done by gas jet.

10. The method of claim 7 where ejection is done by gas jet.

11. The method of claim 8 where ejection is done by gas jet.

12. The method of claim 6 wherein optical sensing uses optical density differentiation to distinguish defect-containing pulp from defect-free pulp particles.

13. The method of claim 8 wherein optical sensing uses optical density differentiation to distinguish defect-containing pulp from defect-free pulp particles.

14. The method of claim 6 wherein dry pulp is crumbled before being optically sensed to reduce agglomeration of particles.

15. The method of claim 1 wherein prior to drying, the pulp is processed by heating and/or shearing to modify the structure and functionality of native fruit pulp.
